(19) United States
(12) Patent Application Publication
(10) Pub. No.: US 2025/0292407 A1
(43) Pub. Date: Sep. 18, 2025

(54) PROCESSING MAGNETIC RESONANCE IMAGING DATA

(71) Applicant: Norwegian University of Science and Technology (NTNU), Trondheim (NO)

(72) Inventors: Gabriel Addio Nketiah, Trondheim (NO); Alexandros Patsanis, Oslo (NO); Mattijs Elschot, Trondheim (NO); Tone Frost Bathen, Trondheim (NO); Mohammed Rasem Sadeq Sunoqrot, Trondheim (NO)

(21) Appl. No.: 18/862,404

(22) PCT Filed: May 5, 2023
(86) PCT No.: PCT/EP2023/061976

§ 371 Date: Nov. 1, 2024

(30) Foreign Application Priority Data
May 5, 2022 (GB) 2206589.0

(51) Int. Cl. G06T 7/00

(52) U.S. Cl. CPC G06T 7/0014; G06T 2207/10088; G06T 2207/20081; G06T 2207/20084; G06T 2207/30081; G06T 2207/30096

(57) ABSTRACT

A computer-implemented method of processing magnetic resonance (MR) imaging data comprises receiving MR imaging data for a region of interest in a body of a human or animal subject, inputting the MR imaging data to a trained machine learning model, operating the trained machine learning model to generate location data representative of a probability of cancer at a location in the region of interest, and processing the location data to generate a human-readable image of the region of interest indicative of the probability of cancer at the location.

### BACKGROUND

The invention relates to methods, apparatus and software for processing magnetic resonance (MR) imaging data.

Magnetic Resonance Imaging (MRI) is a valuable tool for the detection and localization of many types of cancer, including prostate cancer (PCa). Traditionally, two (biparametric) or multiple (multiparametric) MRI images—e.g. T2-weighted (T2W) MR images and/or diffusion-weighted (DW) MR images—are qualitatively analysed by a radiologist in order to identify potential risk areas of PCa within a patient. One or more biopsies are then typically taken from identified risk areas for further analysis in order to produce a diagnosis for the patient. Such qualitative methods of analysing MRI images are time-consuming by nature, and there exists substantial inter-observer variability between different radiologists. They also under-utilize the MRI images since some important information can be embedded in such images that is beyond human vision or perception.

Embodiments of the present invention aim to address at least some of the issues outlined above.

### SUMMARY OF THE INVENTION

According to a first aspect, the invention provides a computer-implemented method of processing magnetic resonance (MR) imaging data, the method comprising:
receiving MR imaging data for a region of interest in a body of a human or animal subject;
inputting the MR imaging data to a trained machine learning model;
operating the trained machine learning model to generate location data representative of a probability (i.e. a likelihood) of cancer at a location in said region of interest;
processing the location data to generate a human-readable image of the region of interest indicative of the probability (i.e. likelihood) of cancer at said location.

In a set of embodiments, the region of interest comprises at least a portion of a prostate.

In a set of embodiments, the MR imaging data comprises one or more MR images. In a set of embodiments, the MR imaging data comprises one or more T2-weighted MR images and/or one or more diffusion-weighted MR images. Each image in the MR imaging data may be received from an MRI scanner or may be generated (i.e. calculated) from a respective image received from an MRI scanner. In some embodiments, the MR imaging data may comprise one or more images received from the MRI scanner and additionally comprise one more generated images.

In a set of embodiments, the location data comprises, for each of one or more MR images in the MR imaging data, a respective probability map comprising, for each of a plurality of pixels in the MR image, data indicative of a probability of the region of the body containing cancer at a location corresponding to the respective pixel.

In a set of embodiments, the step of processing the location data comprises applying a smoothing or noise-reducing filter to each probability map.

In a set of embodiments, the step of processing the location data comprises calculating local maxima across each probability map. In a set of embodiments, processing the location data comprises detecting local intensity peaks across each probability map. In a set of embodiments, processing the location data to generate the human-readable image comprises, for an MR image of the one or more MR images, projecting the respective probability map, optionally with local maxima and/or intensity peaks, onto the MR image.

In a set of embodiments, the method comprises processing the location data to generate, for at least one of the one or more MR images in the MR imaging data, a lesion detection map comprising, for each pixel in the MR image, a binary indicator having a first value when the respective pixel is determined to correspond to a location containing cancer (e.g. having a high likelihood), and having a second value when the respective pixel is determined to correspond to a location not containing cancer (e.g. having a low likelihood).

In a set of embodiments, generating the lesion detection map comprises:
for each of a plurality of voxels extracted from the one or more MR images in the MR imaging data, comparing the data indicative of the probability of the location corresponding to said voxel containing cancer to a voxel-level threshold value; and
determining one or more candidate lesions, each candidate lesion comprising a group of adjacent voxels having associated probabilities that exceed the voxel-level threshold value.

In a set of embodiments, generating the lesion detection map comprises:
determining a respective diameter and/or volume of each candidate lesion;
comparing each respective diameter and/or volume to a size threshold value; and
discarding each candidate lesion having a respective diameter and/or volume falling below the size threshold value.

In a set of embodiments, generating the lesion detection map comprises applying an erosion filter to each candidate lesion, and discarding any candidate lesions which are substantially removed through application of the erosion filter.

In a set of embodiments, generating the lesion detection map comprises:
calculating, for each candidate lesion, a respective probability indicative of the likelihood of it corresponding to a region of clinically significant cancer;
calculating a lesion-level threshold value based on the respective probabilities associated with each candidate lesion; and
discarding each candidate lesion having a respective probability falling below the lesion-level threshold value.

In a set of embodiments, generating the lesion detection map comprises:
assigning a binary indicator having the first value to each voxel of each remaining candidate lesion; and
for an MR image of the one or more MR images, determining which of the voxels associated with a binary indicator having the first value correspond to pixels in the MR image, and projecting the binary indicators associated with said voxels onto the MR image at the locations of said pixels.

In a set of embodiments, the trained machine learning model comprises a trained radiomics-based classifier model. In a set of such embodiments, the trained radiomics-based classifier model is a gradient boosting model.

In a set of embodiments, the trained machine learning model comprises a generative model trained using a generative adversarial network. In a set of such embodiments, the trained machine learning model comprises a generative model trained using a fixed-point generative adversarial network.

In a set of embodiments, the generative model is arranged to generate an additive map, and wherein processing the location data to generate the human-readable image comprises applying the additive map to the received MR imaging data.

In a set of embodiments, operating the trained machine learning model comprises generating, for each of one or more MR images in the MR imaging data, a respective synthetic MR image representative of a non-cancerous version of the region of interest.

In a set of embodiments, operating the trained machine learning model comprises determining a pixel-wise difference between each MR image and the respective synthetic MR image to generate a respective difference image.

In a set of embodiments, processing the location data comprises calculating, for each difference image, local maxima across the difference image.

In a set of embodiments, processing the location data comprises generating, for each difference image, a binary value indicative of whether the difference image indicates clinically significant cancer.

In a set of embodiments, wherein processing the location data comprises projecting each difference image onto the respective MR image in the MR imaging data to generate a respective human-readable image of the region of interest.

According to a second aspect, the invention provides a computer-implemented method of training a machine learning model for processing magnetic resonance (MR) imaging data, the method comprising:
receiving training data comprising, for each of a plurality of human or animal subjects, respective MR imaging data for a region of interest in the body of the human or animal subject and associated diagnosis data comprising an indication of whether said MR imaging data shows clinically significant cancer in the region of interest;
using the training data to train a machine learning model that is arranged to receive, as input, MR imaging data of the region of interest in a body of a human or animal subject, and to generate, as output, location data representative of a probability of cancer at a location in the region of interest.

In a set of embodiments, the region of interest comprises at least a portion of a prostate.

In a set of embodiments, the machine learning model comprises a radiomics-based classifier model.

In a set of embodiments, the machine learning model comprises a generative model and wherein training the machine learning model comprises using an adversarial model to perform generative-adversarial network training.

In a set of embodiments, the training data comprises, for each of the plurality of human or animal subjects, a respective set of one or more MR images. In a set of embodiments, the training data comprises, for each of the plurality of human or animal subjects, a respective set of one or more T2-weighted MR images and/or one or more diffusion-weighted MR images.

In a set of embodiments, the method comprises processing the training data by generating, for each of one or more MR images in the training data, respective data indicative of a location of the region of interest in the MR image and/or data indicative of a location of an area of clinically significant cancer in the MR image.

In a set of embodiments, the method comprises:
processing the training data by selecting, using a quality control system, an optimal one of a plurality of methods for generating respective data indicative of a location of the region of interest in the MR image and/or data indicative of a location of an area of clinically significant cancer in the MR image; and
using the selected optimal method to generate, for each of one or more MR images in the training data, respective data indicative of a location of the region of interest in the MR image and/or data indicative of a location of an area of clinically significant cancer.

In a set of embodiments, the method comprises processing the training data by performing intensity normalisation over each of one or more MR images in the training data.

In a set of embodiments, the intensity normalisation is performed by performing dual-reference tissue-normalisation over each of one or more MR images in the training data.

In a set of embodiments, the intensity normalisation is performed using an AutoRef normalisation method.

In a set of embodiments, the method comprises processing the training data by calculating, for each of one or more diffusion weighted MR images in the training data, a respective Apparent Diffusion Coefficient (ADC) image and a respective high-b-value diffusion-weighted image.

In a set of embodiments, the method comprises processing the training data by applying a correction algorithm to each of one or more MR images in the training data to reduce low-frequency intensity non-uniformity in the respective MR image.

In a set of embodiments, the correction algorithm comprises an N4 bias field correction algorithm.

In a set of embodiments, the method comprises processing the training data by generating, for each of one or more MR images in the training data, respective data indicative of radiomics and anatomical features.

In a set of embodiments, generating data indicative of anatomical features for each MR image in the training data comprises calculating, for each pixel in the MR image, a respective probability score indicative of a probability that the pixel is in a predetermined portion of the region of interest.

In a set of embodiments, calculating a probability score for each pixel comprises inputting each pixel in the MR image to a trained nnUNet deep learning model.

In a set of embodiments, the region of interest comprises at least a portion of the prostate; and the probability score is indicative of the probability that the pixel indicates a location within one of two predetermined portions of the prostate.

In a set of embodiments, the method comprises processing the training data by generating, for each of one or more MR images in the training data, a respective plurality of cropped images.

In a set of embodiments, the method comprises generating the cropped images using a random or strided cropping process.

In a set of embodiments, the method comprises generating the cropped images using a CroPRO cropping method.

The invention extends to software (and to a non-transitory computer-readable storage medium bearing the same) comprising instructions that, when executed by a computer processing system, cause the computer processing system to perform any of the methods disclosed herein.

The invention also extends to a processing system configured to perform any of the methods disclosed herein. Steps disclosed herein may be carried out by hardware (e.g. ASICs or FPGAs or other circuitry) or by software or by a combination of hardware and software. The processing system may comprise one or more processors and a memory storing software for execution by the one or more processors.

### BRIEF DESCRIPTION OF THE DRAWINGS

Embodiments of the invention will now be described, by way of example only, with reference to the accompanying drawings in which:

FIG. 1 shows a flow diagram illustrating a method of training and using a machine learning model to detect cancer in MR images according to some embodiments of the invention;

FIG. 2 shows an SHAP summary plot showing the importance and effects of the most contributing features to a model embodying the invention;

FIG. 3 shows examples of tumor probability maps produced by a model according to an embodiment of the invention;

FIG. 4 shows an FROC analysis showing the utility of radiomics based machine learning, as used in some embodiments, in detecting clinically significant prostate cancers on the lesion level;

FIG. 5 shows an ROC analysis on per-patient level comparing the performance of radiomics-based machine learning, as used in some embodiments, with clinical PI-RADS reading by radiologist in detection of clinically significant prostate cancer;

FIG. 6 shows a flow diagram illustrating a method of training and using a machine learning model to detect cancer in MR images according to some embodiments of the invention;

FIG. 7 shows a flow diagram that represents the three different scenarios that were evaluated: merged, parallel and single modality training;

FIG. 8 shows two graphs illustrating the AUCs for all training scenarios, merged, parallel and single modality training;

FIG. 9 shows images indicating the ability of a model embodying the invention to find the malignant area on DWI and ADC images, while it could not find the malignant area on T2W images for two different patients;

FIG. 10 shows a table containing information about the scan settings of the in-house dataset;

FIG. 11 shows a flow diagram illustrating a method of training and using a machine learning model to detect cancer in MR images according to some embodiments of the invention;

FIG. 12 shows examples of MR images as well as a predicted cancer probability map and a lesion detection map generated using methods according to some embodiments of the invention;

FIG. 13 shows a flow diagram illustrating a method of training and using a machine learning model to detect cancer in MR images according to some embodiments of the invention; and

FIG. 14 shows MR images demonstrating various stages of using a machine learning model to detect cancer according to some embodiments of the invention.

### DETAILED DESCRIPTION OF THE DRAWINGS

The following description describes a number of different sets of embodiments of systems and methods for detecting cancer. They focus on prostate cancer, although approaches disclosed herein could be applied to other types of cancer. The descriptions include details of experimental validations of various approaches embodying the invention.

A first set of embodiments, described in more detail below, uses radiomics-based machine-learning approaches to develop tumor probability maps. Such radiomics-based approaches can be useful for providing interpretability of the models.

A second set of embodiments, described in more detail further below, uses generative adversarial network (GAN) deep-learning approaches to detect the presence and location of cancer.

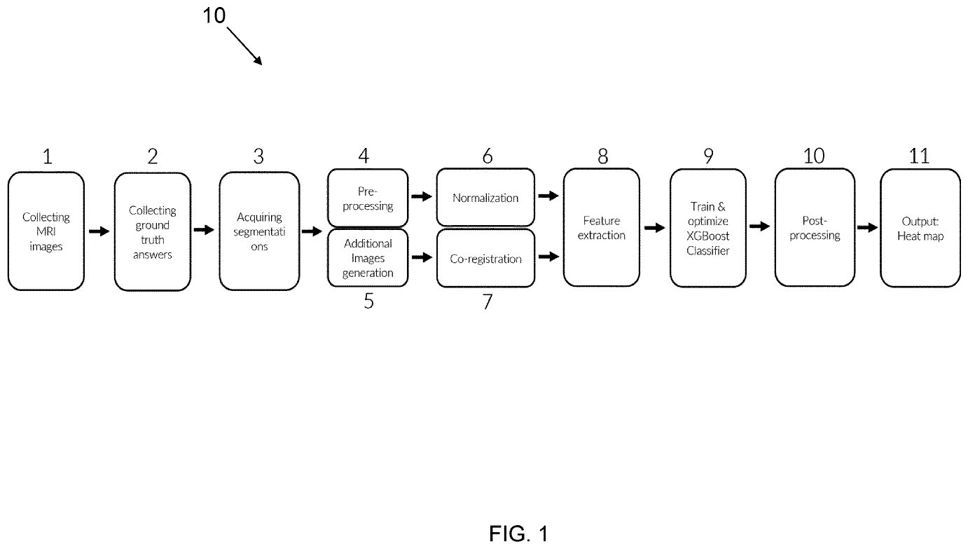

With regard to the first set of embodiments, FIG. 1 provides a high-level view of a first process 10 for training and using a radiomics-based machine-learning model to detect cancer in MR images.

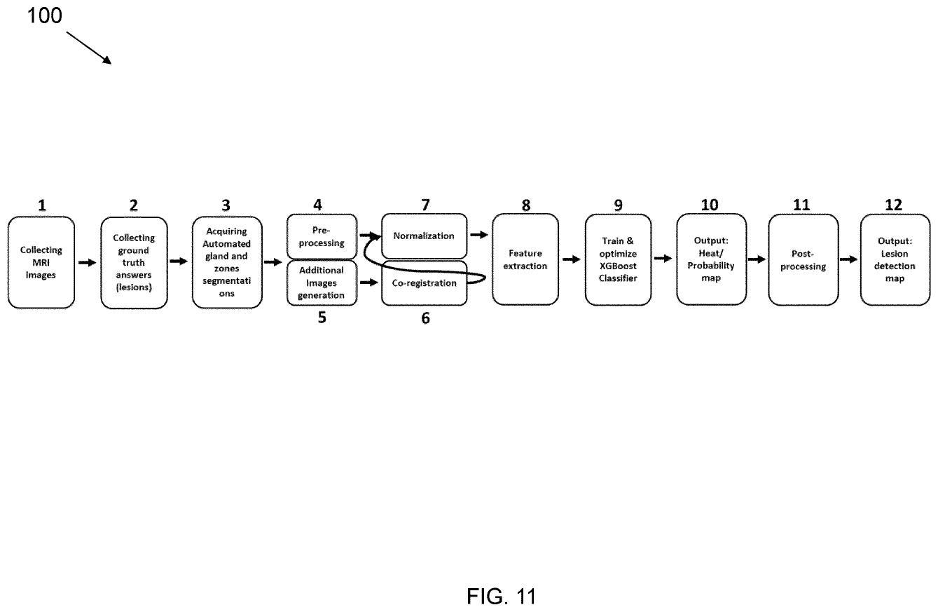

Also with regard to the first set of embodiments, FIG. 11 provides a high-level view of a second process 100 for training and using a radiomics-based machine-learning model to detect cancer in MR images. The second process 100 comprises many of the same steps as the first process 10, with the addition of a further step of outputting a lesion detection map based on a heat map (also referred to herein as a probability map) generated by the machine-learning model. Additionally, the second process 100 includes performing a normalization step on every MR image, including on additionally generated and co-registered images.

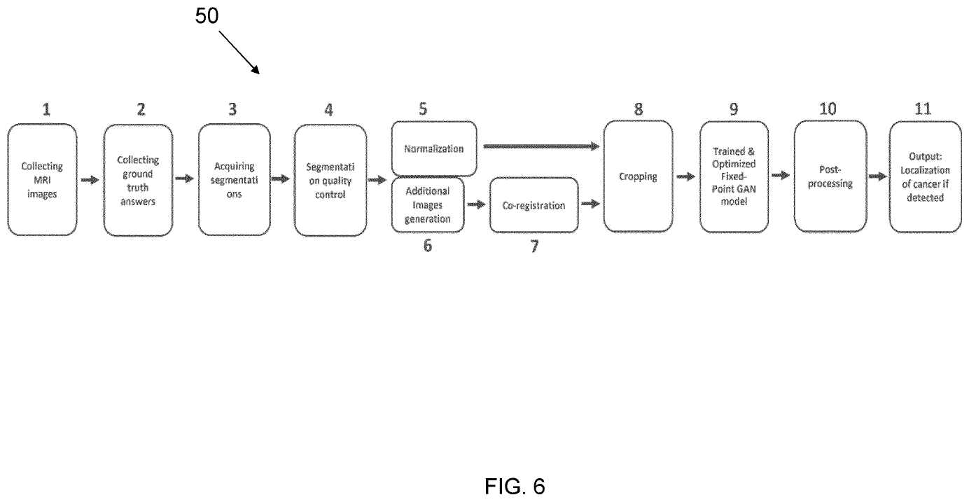

With regard to the second set of embodiments, FIG. 6 provides a high-level view of a third process 50 for GAN-based training and use of a deep-learning model to detect cancer in MR images.

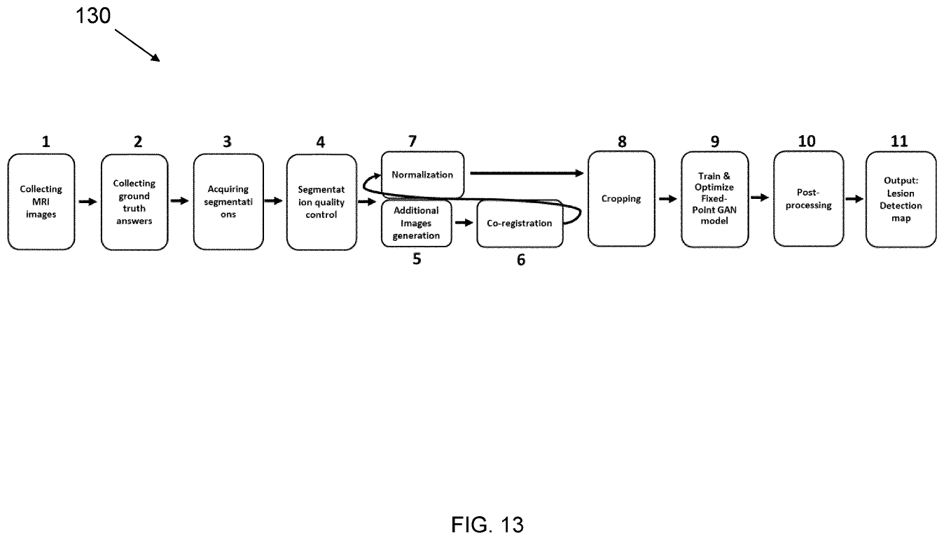

Also with regard to the second set of embodiments, FIG. 13 provides a high-level view of a fourth process 130 for GAN-based training and use of a deep-learning model to detect cancer in MR images. The fourth process 130 includes many of the same steps as the third process 50, with the main difference being that the steps of additional image generation, co-registration, and normalization being performed in sequence rather than in parallel as shown in FIG. 6.

Some embodiments may combine elements of these radiomics-based methods and these GAN-based methods.

First, a radiomics-based approach will be described in detail. This builds on elements of the high-level overview shown in FIG. 1.

### Radiomics-Based Machine Learning for Predicting Clinically Significant Cancer in Multicenter Cohort: Comparison to PI-RADS Reading

### SUMMARY

Background: Recently, predictive machine learning models have shown promise for prostate cancer diagnosis. The utility of MRI radiomics in prostate cancer detection and classification has been shown several studies, but mostly using relatively small and single centre cohort, and lack comparison to clinical assessment.

Purpose: To evaluate the performance of MRI radiomics-based machine learning model for detection and classification of clinically significant prostate cancers in large multicentre settings, relative to clinical PI-RADS assessment.

Methods: Biparametric prostate MR images (3.0T Magnetom Trio/Skyra T2-weighted and diffusion-weighted) from three independent datasets: the PROSTATEx challenge training (N=199), Prostate Cancer localization with a Multiparametric MR Approach trial (PCaMAP, N=96), and an in-house collected (St. Olavs Hospital, Trondheim, Norway, N=158) dataset were retrospectively analyzed in study. Targeted biopsy/prostatectomy results were used as ground truth to manually segment tumor volumes on MR images, with clinically significant prostate cancer defined as International Society of Urological Pathology grade group ≥2. Voxel-wise radiomics features were extracted from the prostate volume. Extreme gradient boosting (XGboost) classifier was internally validated on the PROSTATEx and PCaMAP data through 5-fold cross-validation for training, and externally validated on the in-house dataset as test set.

Results: On the lesion-level analysis, the model achieved a sensitivity of about 82% at 1 false positive per normal case. On the patient-level analysis, PI-RADS reading by radiologist achieved AUC of 90% whilst machine model achieved AUC of 89%.

Conclusions: Radiomics based machine learning models can complement radiological reading in detection of clinically significant prostate cancers and guide targeted biopsy sampling.

### BACKGROUND

Radiomics constitutes automatic high-throughput extraction of quantitative image features from radiological images and their subsequent analysis [Ref. A1-A2]. The utility of radiomics-based machine learning models from MRI in prostate cancer diagnosis has recently gained attention, with huge number of studies [Ref. A3-A7]. However, most of these studies are based on relatively small patient cohorts from single institutions and lack independent comparison with clinical readings, thereby limiting their clinical applicability.

In this large multicenter cohort study, we investigated the utility of a radiomics-based machine learning model for detection of clinically significant prostate cancer foci in comparison to clinical reading according to PI-RADS.

### Materials and Methods

### Datasets

The retrospective analysis was performed using three independent datasets: the PROSTATEx challenge [Ref. A8] training dataset (N=199), the Prostate Cancer localization with a Multiparametric MR Approach trial (PCaMAP) dataset (N=96), and an in-house collected dataset (N=158) from St. Olavs Hospital, Trondheim, Norway. These datasets were collected in 2012, between June 2010-August 2015, and March 2015-December 2017, respectively. A total of six international institutional centers (Radboud University Medical Centre, Nijmegen; Johns Hopkins University, Baltimore; Norwegian University of Science and Technology, Trondheim; University of California, Los Angeles; University Health Network, Toronto; and Medical University of Vienna) contributed to the data. Patient inclusion criteria for the study were consecutive men with a clinical indication for biopsy due to suspicion of prostate cancer (i.e. prostate-specific antigen elevation, clinical examination, or active surveillance), diagnosed with primary prostate cancer and scheduled to undergo preoperative MRI with subsequent radical prostatectomy. Exclusion criteria were history of treatment for prostate cancer, and incomplete sequences or severe MRI artifacts. The PCaMAP trial consortium review board, and the Regional Committee for Medical and Health Ethics (Mid Norway) approved this study and waived the requirement for written informed consent.

In some embodiments, additional publicly available training datasets and shared data were also used for development of machine learning models embodying the principles disclosed here. In some embodiments, additional private datasets, obtained under completely blinded conditions, were used for testing.

### MRI Protocol

A 3.0T Magnetom Trio or Skyra system (Siemens Medical Solutions, Erlangen, Germany) using standard vendor-supplied multichannel body and spine phased-array coils, without an endorectal coil. The acquisition protocol consisted of T₂W, DW and DCE imaging in accordance with institutional and international guidelines. This study utilized only the transverse T₂W and DW images.

### PI-RADS and Histopathology Assessment

The PROSTATEx and in-house datasets (pre-biopsy images) were read by expert radiologists (≥20 years' and ≥10 years' experience respectively), who indicated point-based suspicious findings and assigned PI-RADS scores in accordance with PI-RADS V1 guidelines. Findings with PI-RADS score ≥3 were referred to MRI-guided biopsy. The biopsy specimens were subsequently graded by a pathologist with over 20 years of experience.

For the PCaMAP cohort, each patient underwent radical prostatectomy within 12 weeks after the MRI examination. The prostatectomy specimens were prepared locally according to histopathology protocols at each institution, and then examined by an experienced uro-pathologist who outlined cancer foci, described cancer location, and graded them in accordance with the Gleason scoring system.

### Lesion and Prostate Segmentation

For each dataset, the lesion and prostate volumes were retrospectively segmented on the T₂W images based on clinical reports from biopsy (PROSTATEx & in-house dataset) or prostatectomy (PCaMAP dataset).

The PROSTATEx dataset was segmented by a board-certified radiologist at Miller

School of Medicine, Miami, Florida, USA. That of the in-house dataset was performed by a resident radiologist (with ≥2 years' experience) at St. Olav's Hospital, Trondheim, under the supervision and in consensus with a senior radiologist (with ≥10 years' experience), using a polygon tool from open-source ITK-SNAP software (version 3.6.0, 2017) [Ref. A9].

The PCaMAP dataset was segmented by an investigator, with ≥5 years' experience in prostate MRI. First, a radiologist and a physicist with ≥11 and 6 years' experience in prostate MRI, respectively, in consensus indicated tumor foci (spheres) using semi-automatic tool from MeVisLab (MeVis Medical Solutions) by establishing correspondence between histopathology and MRI based on anatomical landmarks. These spherical tumor foci were manually adapted by the investigator to match the actual shape of tumor as they appear on the T₂W images. The presence of Grade Group ≥2 [Ref. A10] in the biopsies or prostatectomy specimens was used to label each lesion as clinically significant or insignificant cancer.

### Preprocessing & Feature Extraction

The T₂W images were corrected for intensity non-uniformity and intensity non-standardness using the N4 bias field correction [Ref. A11] and dual-reference tissue normalization, using AutoRef [Ref. A12], respectively. PyRadiomics toolkit [Ref. A13] was used to extract (in 2D) voxel-wise radiomics features based on first-order statistics (number of features, nf=19), gray level co-occurrence matrix (GLCM, nf=24), gray level run length matrix (GLRLM, nf=16), gray level size zone matrix (GLSZM; nf=16), neighboring gray tone difference matrix (NGTDM; nf=5), and gray level dependence matrix (GLDM; nf=14) from the whole prostate volumes. Anatomical feature maps consisting of relative distance to the prostate boundary (RDB), peripheral zone likelihood (PZL), and relative positions in x (Xpos), y (Ypos) and z (Zpos) directions were also calculated. PZL was extracted by using the 3D model from the publicly available segmentation method, nnU-Net [Ref. A14]. This segmentation model was trained on a dataset of 182 patients (examined at St. Olavs Hospital, Trondheim, between March 2015 and December 2017. REC (Central Norway) approved the use of the dataset) and all the patients signed informed consent prior to the initiation of the prospective study. In some embodiments, gland and zones segmentation was also automatically performed using the nnU-Net segmentation method.

In some embodiments, for DW image analysis, high b-value (b=1500 s/mm²) images and apparent diffusion coefficient (ADC) maps were derived (i.e. generated) from the non-zero b-value DW images (50-800 s/mm² inclusive) using the monoexponential model. In other embodiments, where high b-value DW and/or ADC map images are available from the scanner, these are used, but they will be generated if they are unavailable.

The calculated (or, optionally, received) high b-value images and ADC maps were co-registered to the corresponding diffusion-weighted images via intensity-based rigid registration (Elastix toolbox [Ref. A15]) using Mattes mutual information similarity metric. The registrations were visually verified, and manually corrected in case of mis-registration, for instance due to geometric distortion. First-order statistical radiomics features were also calculated from the co-registered high b-value images and ADC maps. In some embodiments, these co-registration parameters may then optimized.

In some embodiments, e.g. those implementing steps shown in FIG. 11, the high b-value DW images and ADC map images, co-registered to T₂W images, may also be normalized, e.g. using Gaussian normalization. The high b-value DW images may be normalized using mean and standard deviations calculated from individual patients. The ADC map images may be normalized using global mean and standard deviation calculated from prostate volume intensities in the training set.

In some embodiments, after segmentation, post-processing was performed using customized code in order to improve the overall quality of the segmented images. Further, in some embodiments, MR images were resampled to an in-plane resolution of 0.5×0.5.

In some embodiments, for some datasets, where high b-value DW and/or ADC map images were available from the scanner, these were used directly rather than calculated as outlined above. Where such images were unavailable, these were calculated.

### Machine Learning

Cancer probability maps were obtained by training an Xtreme gradient boosting (XGBoost) classifier [Ref. A 16] to predict the likelihood of a voxel being clinically significant cancer. To preserve the multicenter nature of the data, the classifier training and hyperparameter optimization (using 5-fold cross-validation) was done on the PROSTATEx and PCaMAP datasets, and testing on the in-house dataset.

Additional testing was performed on privately obtained datasets under completely blinded conditions. The optimization was performed using Optuna [Ref. A17], which is open source hyperparameter optimization framework to automate hyperparameter search. Erosion filtering was applied on the classifier generated cancer probability maps. Local maxima indicative of cancer hotspots were detected on cancer probability maps using a spherical window with 10 mm radius. Free-response receiver-operating characteristic curve (FROC) analysis was performed on local maxima to evaluate model performance on lesion-level. Here, a local maximum was considered true positive if it was above the optimized cutoff (=0.36) and it lies within 5 mm from a clinically significant lesion annotation by the radiologist. For patient-level evaluation, ROC analysis was used. Local peak probability [Ref. A18] was calculated as the average value within a circle with 5 mm radius at each local maximum, and the maximum value was taken as the representative cancer probability for the patient. PI-RADS readings were available for comparison.

In some embodiments, morphological operations—e.g. dusting, opening, 3D largest connected components (26-direction), and removing clustered areas with a volume of less than 0.5 mL—were performed as part of a post-processing step on probability maps generated by the machine learning model. Further, in some embodiments, one or more thresholds/cut-offs were applied to generate a lesion detection map, e.g. as described in more detail elsewhere herein.

### Results

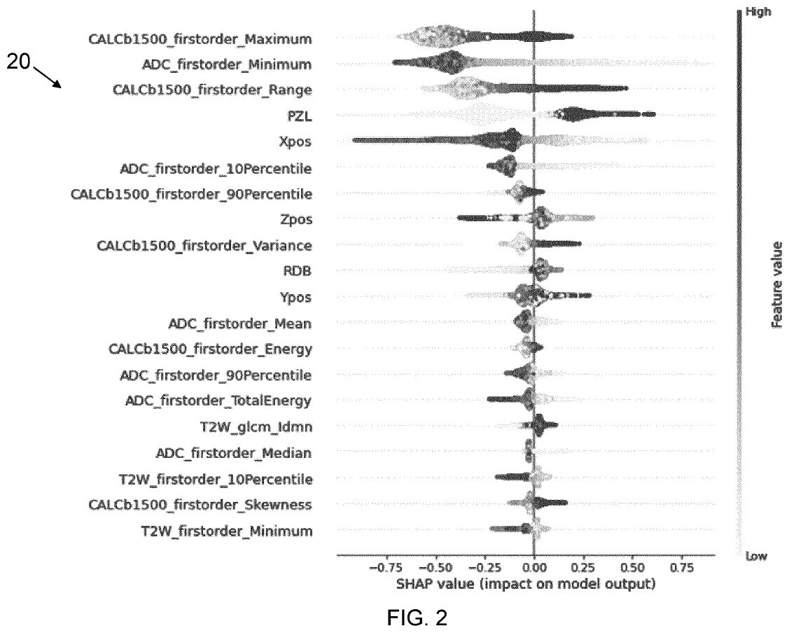

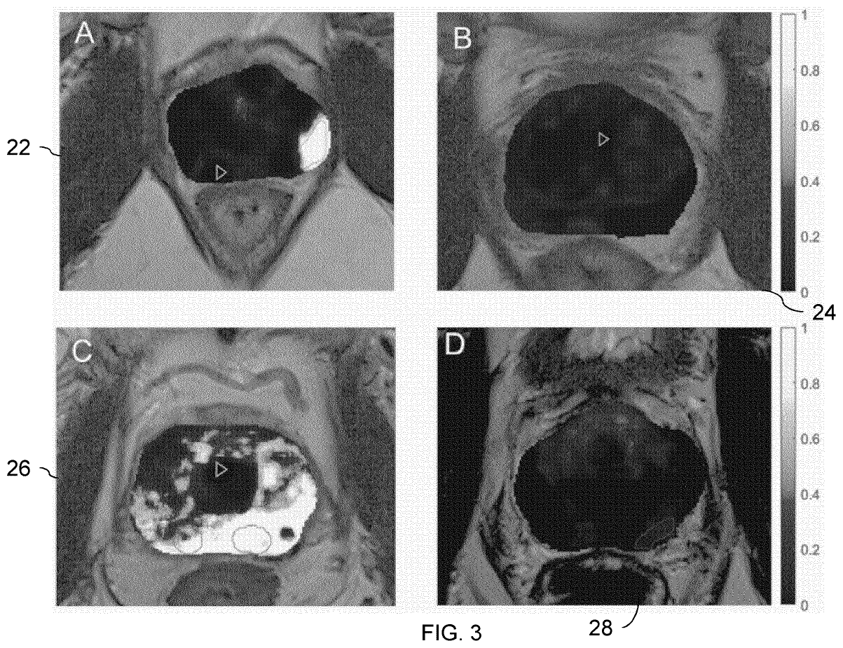

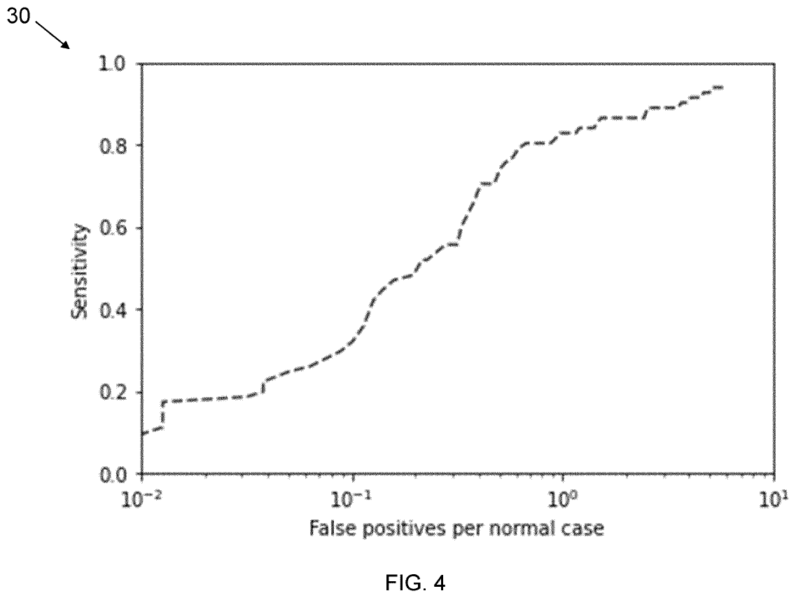

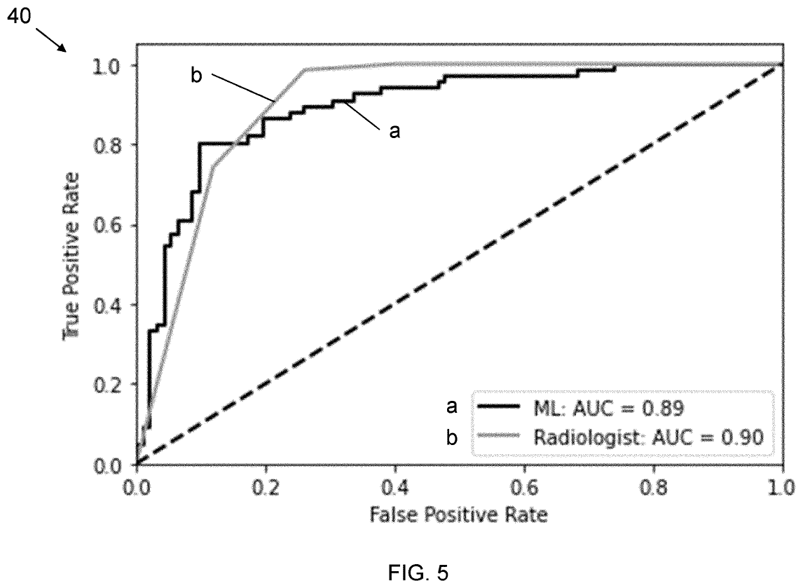

In the training cohort (N=295 patients), there were 161 significant cancers in 143 patients, of which 110 lesions (N=100) were in the PZ and 51 (N=43) in transition zone (TZ). In the test cohort (N=158), 81 significant cancers were present in 67 patients, which consisted of 55 PZ cancers (N=48) and 26 TZ cancers (N=19). First-order statistical radiomics features mainly constituted the most important features in model (FIG. 2). FIG. 3 depicts example cancer probability maps. The FROC curve in FIG. 4 shows the performance of the model in detecting significant cancers. On the patient-level analysis (see FIG. 5), PI-RADS reading by radiologist achieved AUC of 90% whilst machine learning achieved AUC of 89%

### Discussion

In this study, we showed that radiomics-based machine learning can perform relatively well compared to clinical practice, when trained on large data form multicentre settings.

A unique strength of this study besides the multicenter patient cohort is that we employed both spectrums of AI (deep vs classical machine learning) to ensure optimal results. Deep Learning was used to perform segmentation tasks to generate anatomical features (i.e. PZL) because it is highly accurate and established for such tasks. However, a classical machine learning approach, a radiomics-based model, was used for classification to avoid the black-box dilemma of Deep Learning and to create more transparent and trustworthy model.

This study could offer several practical advantages to complement the radiological reading. First, it combines multiple images into a single feature map (i.e., cancer probability map), which reduces the number different imaging modalities to be evaluated and thus workload.

Unnecessary biopsies and/or False positive detections constitute major concerns in prostate cancer detection due to the associated side effects (e.g., biopsy-related infection) and cost. Thus, the quantitative and objective nature makes it a potential suitable tool for initial screening to rule out a subset of patients not requiring biopsy. Finally, if biopsy is required, the probability maps (e.g., hotspots) can be used to guide sampling and potentially reduce the number of expected biopsy cores per patient.

In future we seek to investigate the clinical feasibility and efficacy of the model especially in relation to sensitivity and specificity.

### Conclusion

Radiomics-based machine learning model from MR images can achieve a comparable AUC in detecting classification prostate cancers relative to clinical reading according to PI-RADS. This could complement radiological reading and to guide targeted biopsy sampling to help reduce unnecessary number of biopsy cores, and thus the risk of post-biopsy infection and complications.

### Optional Features

FIG. 11 provides a high-level view of a variant process 100 comprising many of the same steps as the first process 10 shown in FIG. 1, but also comprising a further step of outputting a lesion detection map based on a heat map (also referred to herein as a probability map) generated by the machine-learning model. Additionally, the second process 100 includes performing a normalization step on every MR image, including on additionally generated and co-registered images. One or both of these steps may optionally be implemented in embodiments disclosed herein.

In order to generate the respective lesion detection maps, the second process 100 shown in FIG. 11 may include one or more of the following steps:
for each of a plurality of voxels extracted from one or more MRI images in the MRI images, comparing the probabilities in the probability map associated with said voxel to a voxel-level threshold value;
determining one or more candidate lesions, each candidate lesion comprising a group of adjacent voxels having associated probabilities that exceed the voxel-level threshold value;
determining a respective diameter and/or volume of each candidate lesion;
comparing each respective diameter and/or volume to a size threshold value;
discarding each candidate lesion having a respective diameter and/or volume falling below the size threshold value;
applying an erosion filter to each remaining candidate lesion, and discarding any candidate lesions which are substantially removed through application of the erosion filter;
calculating, for each candidate lesion, a respective probability indicative of the likelihood of it corresponding to a region of clinically significant cancer;
calculating a lesion-level threshold value based on the respective probabilities associated with each candidate lesion; and
discarding each candidate lesion having a respective probability falling below the lesion-level threshold value;
assigning a binary indicator having a first value to each voxel of each remaining candidate lesion, the first value indicating that the respective voxel corresponds to a location in the body having a high probability of containing cancer; and
for an MR image, determining which of the voxels associated with a binary indicator having the first value correspond to pixels in the MR image, and projecting the binary indicators associated with said voxels onto the MR image.

### Figures

FIG. 2 shows an SHAP summary plot 20 showing the importance and effects of the most contributing features to the model.

FIG. 3 shows examples of predicted cancer probability maps back projected into T2-weighted image space. The red outline indicates regions that were marked by the radiologist as potential clinically significant cancers and were confirmed by biopsy (true positive), while the blue indicates regions rebutted by biopsy (false positive). Panels 22, 24, 26 & 28 (labelled A, B, C and D respectively) depict true positive, true negative, false positive and false negative predictions, respectively.

FIG. 4 shows an FROC analysis 30 showing the utility of radiomics based machine learning in detecting clinically significant prostate cancers on the lesion level. At 1 false positive per normal case (blue line), the model achieves a sensitivity of about 82%.

FIG. 5 shows an ROC analysis 40 on per-patient level comparing the performance of radiomics-based machine learning with clinical PI-RADS reading by radiologist in detection of clinically significant prostate cancer.

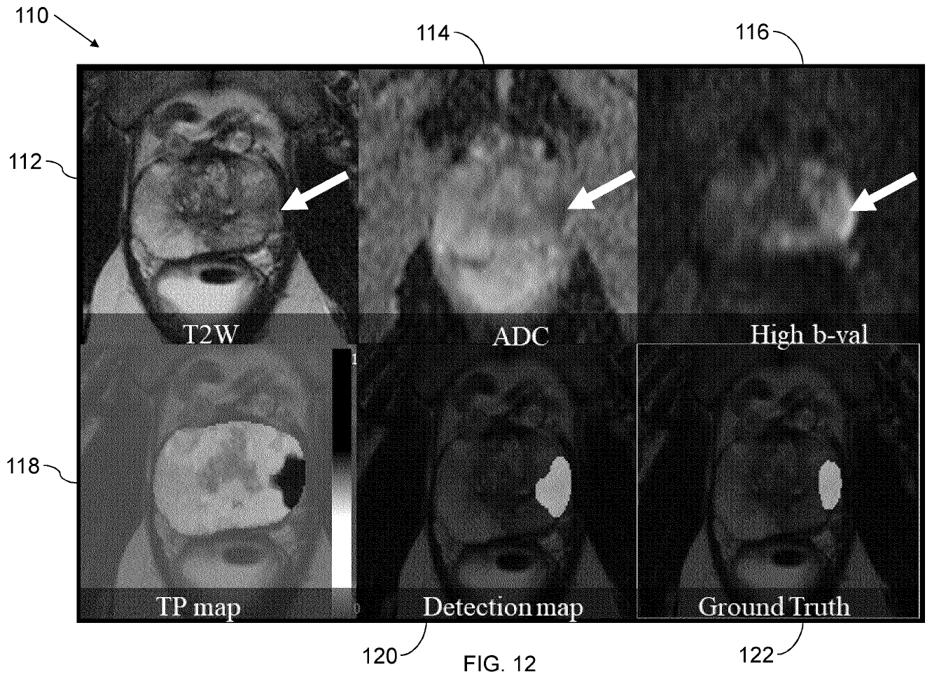

FIG. 12 shows examples 110 of MR images as well as a predicted cancer probability map and a lesion detection map generated according to embodiments of the second process 100 shown in FIG. 11.

Panel 112 shows a T2-weighted MR image of a region of interest in the body (a prostate in this example). Panel 114 shows an apparent diffusion coefficient (ADC) image of the same region, and panel 116 shows a high b-value image of the same region.

Panel 118 shows a probability map generated using a radiomics-based machine learning model as described above, projected onto T2-weighted image space. Within the region of interest, dark pixels indicate a higher likelihood of cancer, while lighter pixels indicate a lower likelihood.

Panel 120 shows a lesion detection map projected onto the T2-weighted image space. The lesion detection map has been generated based on the probability map 118 using methods as described above, and indicates, as lighter pixels, an area where the presence of a lesion is predicted.

Panel 122 shows, for the sake of comparison, the ground truth of the same prostate region with the true location of a lesion, as determined through biopsy, highlighted by the lighter pixels.

### REFERENCES

A1. Stoyanova R, Takhar M, Tschudi Y, et al. Prostate cancer radiomics and the promise of radiogenomics. Transl Cancer Res. 2016; 5(4): 432-447.

A2. Gillies R J, Kinahan P E, Hricak H. Radiomics: Images Are More than Pictures, They Are Data. Radiology. 2016; 278(2): 563-577.

A3. Bernatz S, Ackermann J, Mandel P, et al. Comparison of machine learning algorithms to predict clinically significant prostate cancer of the peripheral zone with multiparametric MRI using clinical assessment categories and radiomic features. Eur Radiol. 2020; 30(12): 6757-6769.

A4. Nketiah G, Elschot M, Kim E, et al. T2-weighted MRI-derived textural features reflect prostate cancer aggressiveness: preliminary results. Eur Radiol. 2016.

A5 Nketiah G A, Elschot M, Scheenen T W, et al. Utility of T2-weighted MRI texture analysis in assessment of peripheral zone prostate cancer aggressiveness: a single-arm, multicenter study. Sci Rep. 2021; 11(1).

A6. Fehr D, Veeraraghavan H, Wibmer A, et al. Automatic classification of prostate cancer Gleason scores from multiparametric magnetic resonance images. Proc Natl Acad Sci. 2015; 112(46): E6265-73.

A7. Bonekamp D, Kohl S, Wiesenfarth M, et al. Radiomic Machine Learning for Characterization of Prostate Lesions with MRI: Comparison to ADC Values. Radiology. 2018; 289(1): 128-137.

A8. Geert Litjens, Oscar Debats, Jelle Barentsz, Nico Karssemeijer H H. ProstateX Challenge data. The Cancer Imaging Archive (2017).

A9. Yushkevich P A, Piven J, Hazlett H C, et al. User-guided 3D active contour segmentation of anatomical structures: Significantly improved efficiency and reliability. Neuroimage 2006; 31(3): 1116-1128.

A10. Epstein J I, Zelefsky M J, Sjoberg D D, et al. A Contemporary Prostate Cancer Grading System: A Validated Alternative to the Gleason Score. Eur Urol. 2015; 69(3): 428-435.

A11. Tustison N J, Avants B B, Cook P A, et al. N4ITK: improved N3 bias correction. IEEE Trans Med Imaging. 2010; 29(6): 1310-1320.

A12. Sunogrot M R S, Nketiah G A, Selnæs K M, Bathen T F, Elschot M. Automated reference tissue normalization of T2-weighted MR images of the prostate using object recognition. Magn Reson Mater Physics, Biol Med. 2020.

A13. Van Griethuysen J J M, Fedorov A, Parmar C, et al. Computational radiomics system to decode the radiographic phenotype. Cancer Res. 2017; 77(21): e104-e107.

A14. Isensee F, Jaeger PF, Kohl S A A, Petersen J, Maier-Hein K H. nnU-Net: a self-configuring method for deep learning-based biomedical image segmentation. Nat Methods. 2021 February; 18(2): 203-211.

A15. Klein S, Staring M, Murphy K, Viergever M A, Pluim J P W. elastix: a toolbox for intensity-based medical image registration. IEEE Trans Med Imaging. 2010; 29(1): 196-205.

A16. Chen, T.; Guestrin, C. XGBoost: A Scalable Tree Boosting System. In Proceedings of Proceedings of the 22nd ACM SIGKDD International Conference on Knowledge Discovery and Data Mining, San Francisco, California, USA; pp. 785-794.

A17. Takuya Akiba, Shotaro Sano, Toshihiko Yanase, Takeru Ohta, and Masanori Koyama. Optuna: A Next-generation Hyperparameter Optimization Framework. In KDD. 2019.

A18. Wahl R L, Jacene H, Kasamon Y, Lodge M A. From RECIST to PERCIST: Evolving Considerations for PET Response Criteria in Solid Tumors. J Nucl Med. 2009; 50(Suppl 1): 122S-150S.

Next, a GAN-based approach will be described in detail. This builds on elements of the high-level overview shown in FIG. 6.

### Improving Prostate Cancer Detection Using Bi-Parametric MRI With Conditional Generative Adversarial Networks

### Synopsis

This study investigated automated detection and localization of prostate cancer on biparametric MRI (bpMRI). Conditional generative adversarial networks (cGANs) were used for image-to-image translation. We used an in-house collected dataset of 811 patients with T2-and diffusion-weighted MR images for training, validation, and testing of two different bpMRI models in comparison to three single modality models (T2-weighted, ADC, high b-value diffusion). The bpMRI models outperformed T2-weighted and high b-value models, but not ADC. cGANs show promise for detecting and localizing prostate cancer on MRI, but further research is needed to improve stability, performance and generalizability of the bpMRI models.

### Introduction

Multiparametric MRI (mpMRI) is a valuable tool for the detection and localization of prostate cancer (PCa) [Ref. B1]. Computer-aided diagnosis (CAD) systems have been proposed to help overcoming certain limitations of conventional radiological reading of the mpMRI, such as its time-consuming nature and inter-observer variability [Ref. B2]. In this work, we investigate the use of conditional generative adversarial networks (GANs) for the detection and localization of prostate cancer

(PCa) using biparametric T2-weighted (T2W) and diffusion-weighted (DWI) MR images as input. We approach this task as a weakly supervised (i.e., only image-level labels used to train) image-to-image translation problem, an arena where GANs have previously proven to be successful [Ref. B3-B4], also in the medical imaging domain [Ref. B5]. This work builds on our previous experience with GANs trained on T2W images alone [Ref. B6], and specifically aims to assess potential improvements when using biparametric MR images as input.

### Methods

### Datasets

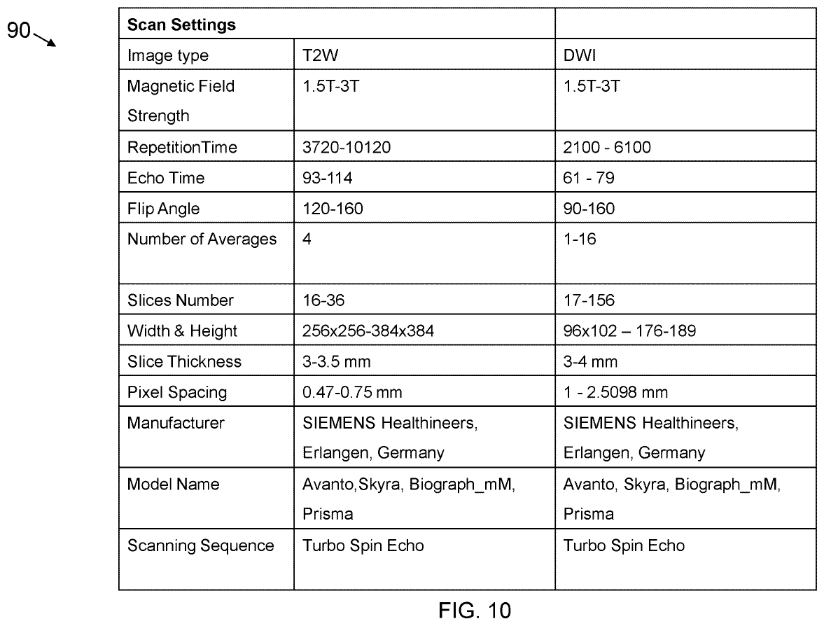

We used in-house collected data of mpMRI from patients (N=811) referred for prostate MRI suspected for PCa at St. Olavs Hospital, Norway from 2013 to 2019. bpMRI images were used to train (N=421), validate (N=40), and test (N=350) several cGANs models. Patients who underwent biopsy and had lesions with a Gleason grade group (GGG) ≥1 were considered as cancer-positive patients. Patients with a negative biopsy or PIRADS <3 who did not undergo biopsy were considered cancer-negative patients. Information about the scan settings of the in-house dataset is contained in FIG. 10.

The Regional Committee for Medical and Health Research Ethics (REC Mid Norway) approved the use of the in-house collected dataset (identifier 2017/576; 5 May 2017) and granted permission for passive consent to be used.

In some embodiments, additional publicly available training datasets and shared data were also used for development of deep-learning models the principles disclosed here. In some embodiments, additional private datasets, obtained under completely blinded conditions, were used for testing.

### Lesion and Prostate Segmentation

For the patients with significant cancer label, the whole prostate and the cancer suspicious VOIs was segmented manually. Manual segmentation was performed using ITK-SNAP (version 3.6.0) [Ref. B7] by a radiology resident at St. Olavs

Hospital, Norway, under the supervision of a radiologist with more than 10 years' experience in prostate imaging.

For the patients with non-significant cancer label, the whole prostate was automatically segmented. This was done using two publicly available 3D segmentation methods, V-Net [Ref. B8] and nnU-Net [Ref. B9], of which the one with the best Quality Control score (using an in-house developed method [Ref. B10]) was chosen for further processing. These segmentation models were trained on a dataset of 60 patients with non-significant cancer label. In some embodiments, only the nnU-Net method was used for segmentation. The patients were examined at St. Olavs Hospital, Trondheim, between March 2015 and December 2017. REC (Central Norway) approved the use of the dataset (identifiers 2013/1869 and 2017/576) and all the patients signed informed consent prior to the initiation of the prospective study.

In some embodiments, after segmentation, post-processing was performed using customized code in order to improve the overall quality of the segmented images.

### Preprocessing

The T2W images were corrected for intensity non-uniformity and intensity non-standardness using the N4 bias field correction [Ref. B11] and dual-reference tissue normalization, using AutoRef [Ref. B12], respectively.

For DW image analysis, high b-value (b=1500 s/mm2) images and apparent diffusion coefficient (ADC) maps were derived (i.e. generated) from the non-zero b-value DW images (50-800 s/mm2 inclusive) using the monoexponential model. The calculated high b-value images and ADC maps were co-registered to the corresponding diffusion-weighted images via intensity-based rigid registration with Elastix v.4.7 [Ref. B13] using Mattes mutual information similarity metric. In some embodiments, the co-registration parameters were optimized.

In some embodiments, e.g. those implementing steps shown in FIG. 13, high b-value DW images and ADC map images were normalized using Gaussian normalization. This may, in some embodiments, be done using Gaussian mean and standard deviation calculated from the individual patients.

The T2W and the driven high b-value and ADC map images were cropped over the prostate area with a size of 128×128 pixels and a pixel spacing of 0.4×0.4 mm², then they were used as input to all investigated models. The cropped images were sampled randomly for the training set, and with structured strides from the top-left to the bottom right of the prostate masks for the test set.

### Model Development

The model development and implementation was according to our previously proposed end-to-end pipeline [Ref. B6], including Fixed Point GAN (FP-GAN) [Ref. B14] for image-to-image translation.

Models were trained using three different scenarios: single, parallel, and merged modality training. In single modality training, each modality (T2W, high b-value, ADC) was trained individually. In case of parallel modality training, the model was trained on images from all modalities simultaneously. For merged modality training, the three image types were merged into a 3-channel image. In some embodiments, it was found, at least for some datasets, that an improved single modality training approach was more effective than other (e.g. parallel) approaches. In the improved single modality approach, the three separate models were trained and used individually in order to generate three detection map outputs, and these three separate outputs were ensembled in order to form a single detection map.

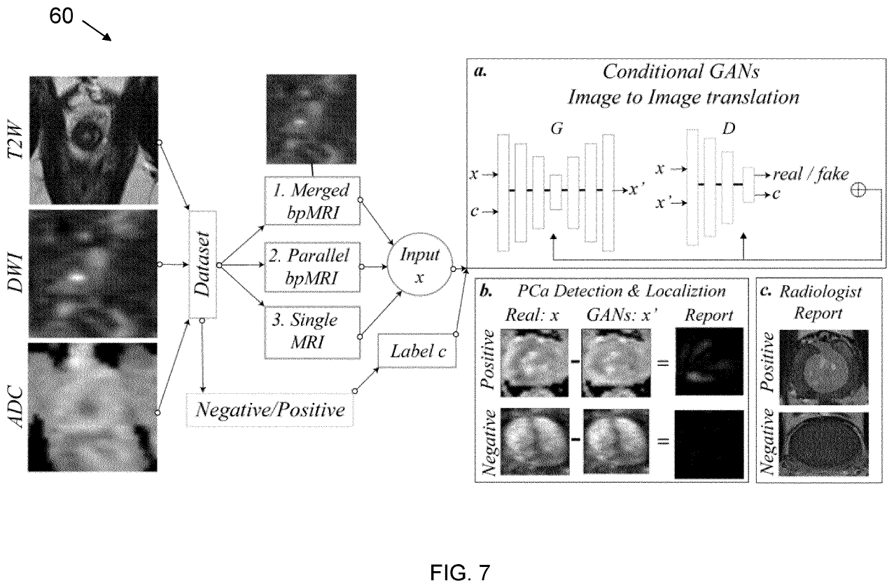

Our goal was to translate images of unknown health status to cancer-negative images. For this purpose, FP-GAN [Ref. B15] was used, which successfully translates identical domains using conditional identity loss. This ensures that the generator will apply the minimum chance to preserve the domain characteristics. FP-GAN generates an additive map, which is applied to the input image (see FIG. 7—panel b) without the need of annotation during reference. Thus, if a negative patient is present, the model will not change anything, while for a positive patient the model will remove potential malignant area to translate the image to negative. Subtracting was applied, where the model generated image subtracted from the original image (T2W/DWI/ADC) to generate a map with abnormal tissue highlighted. For each model, the patient-level area under the receiver operating characteristics curve (AUC) was calculated using the maximum of the difference images [Ref. B15], either as a performance metric to optimize the model (#iterations, validation set) or to compare the performance of bpMRI vs single modality models (test set). In some embodiments, additional testing was performed on privately obtained datasets under completely blinded conditions.

In some embodiments, smooth filtering was applied to the output of the deep-learning model. Further, an anomaly score was calculated for some outputs of the deep-learning model, and an optimized classification threshold/cut-off was applied in order to generate a lesion detection map as described elsewhere herein.

### Results

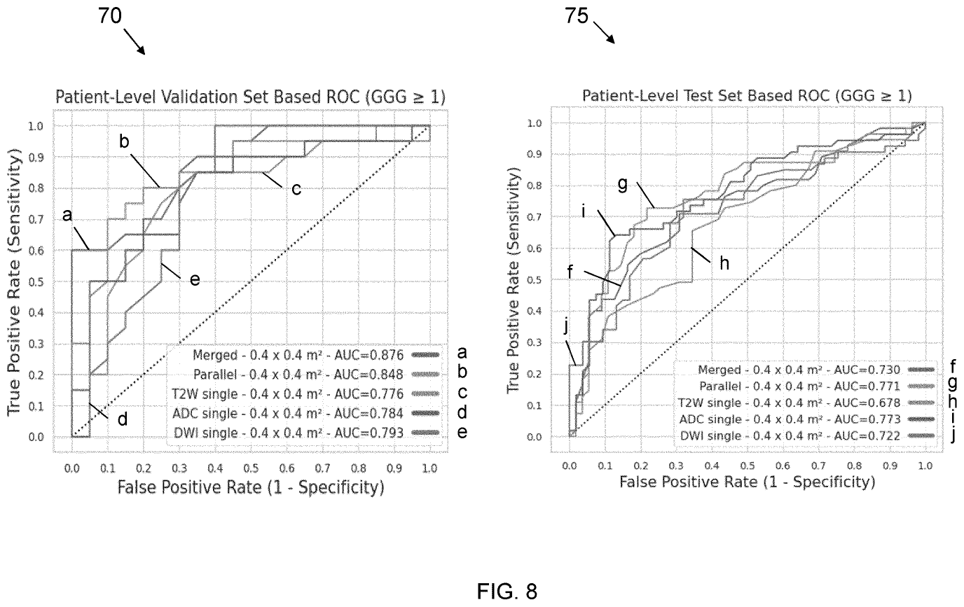

Patient-level validation AUC (see FIG. 8—graph 75) for merged training AUC was equal to 0.876 and parallel training AUC was equal to 0.848, while this was 0.776, 0.784 and 0.793 for T2W, ADC and high b-value, respectively. Patient-level AUC for test set (N=350) resulted in an AUC equal to 0.721 for merged training, 0.771 for parallel training, 0.678 for T2W, 0.773 for ADC and 0.722 for DWI (see FIG. 8—graph 70).

### Discussion

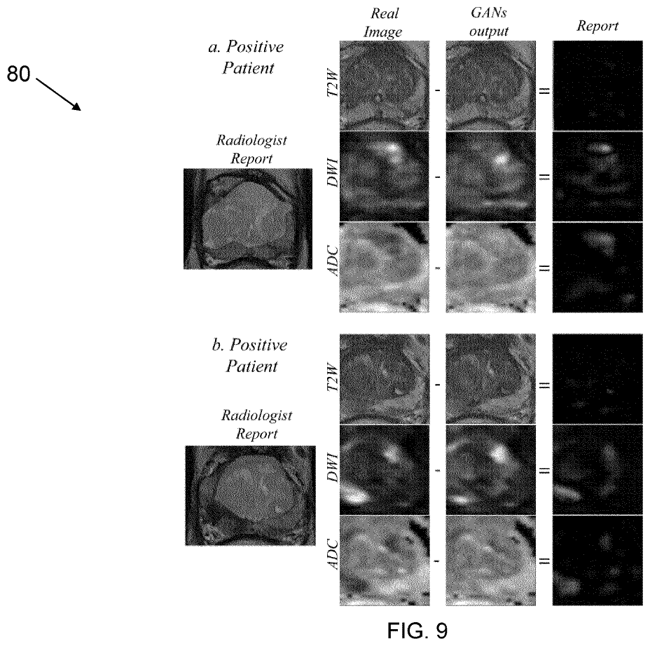

In this study, two cGAN models trained on bpMRI data including T2W, ADC, and high b-value diffusion images were evaluated in comparison those trained with data of these respective single modalities. Our preliminary analysis suggests that both the merged (0.721) and parallel (0.771) bpMRI models increased patient-level AUC compared with T2W (0.678) alone, but not compared with ADC (0.773) alone. Interestingly, the drop in performance from validation to test set was substantially larger for both bpMRI models than for the ADC model. The higher AUC could be due to the number of patients (N=40) which were used for validation set compared with test set (N=350). Importantly, when only T2W was used, the model was unable to detect tumors in some patients. One explanation can be that pixel intensity surrounding the tumor is similar in T2W, while not ADC and DWI images (see FIG. 9), where the model was able to detect tumors. This shows the benefits of using bpMRI for PCa detection and localization. In the future, we aim to improve the performance and generalizability of the model by using cohorts from different providers for training.

### CONCLUSION

Our preliminary results suggest that training conditional GANs on T2W and DWI improves the performance for detection of PCa in comparison to models trained on T2W only, but not in comparison to models trained on ADC only.

### Summary of Main Findings

Conditional GANs were able to detect PCa in ADC and DWI, while failed for some patients on T2W images. The best models were obtained with parallel training (bpMRI) and single ADC training using 0.4×0.4mm2 pixels spacing and cropped images size of 128×128.

### Figures

FIG. 7 shows a flow diagram 60 that represents the three different scenarios that were evaluated: merged, parallel and single modality training. Conditional GANs (cGANs) were trained using the patient's health status (negative/positive) as image level label. The cGANs (a.) were trained to translate any patient status to a negative (healthy) status. (b.) shows an example of inference where the model removes the potentially malignant area from the positive case located in the lower left part of the image where the malignant area exists (c.), while the model makes no changes for the negative case.

FIG. 8 shows two graphs 70, 75 illustrating the AUCs for all training scenarios, merged, parallel and single modality training. T2W had the lowest AUC (0.776) among all patient-level AUC models (graph 70), whereas the highest AUC was obtained by using bpMRI (0.876). However, the patient-level AUC for the 350-patient test set (graph 75) showed that ADC (0.771) and parallel training (0.773) had the best performance.

FIG. 9 shows images 80 indicating the ability of the model to find the malignant area on DWI and ADC images, while it could not find the malignant area on T2W images for two different patients. The examples are taken from parallel training of T2W, ADC and high b-value.

FIG. 10 shows a table 90 containing information about the scan settings of the in-house dataset. Use of the in-house dataset was approved by the Regional Committee for Medical and Health Research Ethics (REC) in central Norway.

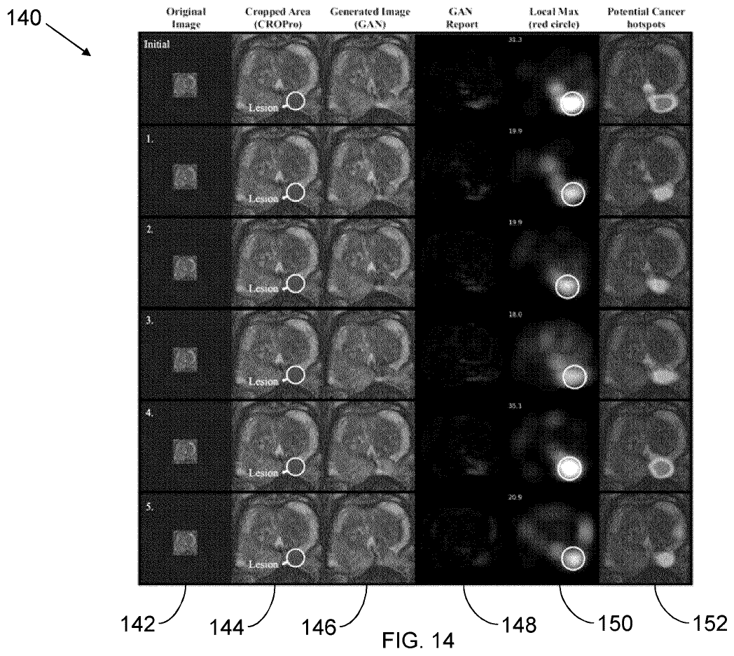

FIG. 14 shows example images 140 illustrating various stages in the exemplary GAN-based processes 50, 130 disclosed herein. Column 142 shows a set of original MR images obtained from a scanner. Column 144 shows a set of cropped images, obtained using the CROPro cropping method, with locations of a lesion ascertained through biopsy shown thereon for the sake of comparison. Column 146 shows a set of synthetic images generated by a GAN model as disclosed herein, showing representative of a non-cancerous version of the region of the body shown in the set of cropped images 144. Column 148 shows a set of difference images generated by determining a pixel-wise difference between each cropped image 144 and each synthetic image 146. Column 150 shows a set of enhanced difference images, with local maxima having been calculated at the region shown by the circled region. Column 152 shows a set of heat or probability maps calculated from the difference images 148, 150 highlighting locations of predicted cancer hotspots.

### REFERENCES

B1. Turkbey B, Rosenkrantz A B, Haider M A, et al. Prostate Imaging Reporting and Data System Version 2.1: 2019 Update of Prostate Imaging Reporting and Data System Version 2. Eur Urol. 2019; 76(3): 340-351.

B2. Lemaître G, Marti R, Freixenet J, et al. Computer-Aided Detection and diagnosis for prostate cancer based on mono and multi-parametric MRI-A review. Computers in Biology and Medicine. 2015; 60(C): 8-31.

B3. Zhang H, Xu T, Li H, et al. StackGAN++: Realistic Image Synthesis with Stacked Generative Adversarial Networks. IEEE Trans Pattern Anal Mach Intell. 2019; 41(8): 1947-1962. doi: 10.1109/TPAMI.2018.2856256

B4. Wang X, Yu K, Wu S, et al. ESRGAN: Enhanced Super-Resolution Generative Adversarial Networks. In: Leal-Taixe L, Roth S, eds. Computer Vision-ECCV 2018 Workshops. Vol 11133. Lecture Notes in Computer Science. Springer International Publishing; 2019: 63-79. doi: 10. 1007/978-3-030-11021-5_5

B5. Kazeminia S, Baur C, Kuijper A, et al. GANs for medical image analysis. Artif Intell Med. 2020; 109: 101938. doi: 10.1016/j.artmed.2020.101938

B6. Patsanis A, Sunoqrot M R S, Sandsmark E, et al. Prostate Cancer Detection on T2-weighted MR images with Generative Adversarial Networks. In: International Society for Magnetic Resonance in Medicine; 2021.

B7. Yushkevich P A, Piven J, Hazlett H C, et al. User-guided 3D active contour segmentation of anatomical structures: Significantly improved efficiency and reliability. Neuroimage 2006; 31(3): 1116-1128.

B8. Milletari, F., Navab, N., Ahmadi, S. A., 2016. V-net: Fully convolutional neural networks for volumetric medical image segmentation, in: 2016 fourth international conference on 3D vision (3DV), IEEE. pp. 565-571.

B9. Isensee F, Jaeger P F, Kohl S A A, Petersen J, Maier-Hein K H. nnU-Net: a self-configuring method for deep learning-based biomedical image segmentation. Nat Methods. 2021 February; 18 (2): 203-211.

B10. Sunoqrot, M. R. S.; Selnaes, K. M.; Sandsmark, E.; Nketiah, G. A.; Zavala-Romero, O.; Stoyanova, R.; Bathen, T. F.; Elschot, M. A Quality Control System for Automated Prostate Segmentation on T2-Weighted MRI. Diagnostics (Basel) 2020, 10, 714.

B11. Tustison N J, Avants B B, Cook P A, et al. N4ITK: improved N3 bias correction. IEEE Trans Med Imaging. 2010; 29(6): 1310-1320.

B12. Sunogrot M R S, Nketiah G A, Selnæs K M, Bathen T F, Elschot M. Automated reference tissue normalization of T2-weighted MR images of the prostate using object recognition. Magn Reson Mater Physics, Biol Med. 2020.

B13. Klein S, Staring M, Murphy K, Viergever M A, Pluim J P W. elastix: a toolbox for intensity-based medical image registration. IEEE Trans Med Imaging. 2010; 29(1): 196-205.

B14. Siddiquee, M. M. R., Zhou, Z., Tajbakhsh, N., Feng, R., Gotway, M. B., Bengio, Y., Liang, J., 2019. Learning fixed points in generative adversarial networks: From image-to-image translation to disease detection and localization, in: Proceedings of the IEEE International Conference on Computer Vision, pp. 191-200.

B15. Rahman Siddiquee MM, Zhou Z, Tajbakhsh N, et al. Learning Fixed Points in Generative Adversarial Networks: From Image-to-Image Translation to Disease Detection and Localization. Vol 2019.; 2019:200. doi: 10.1109/ICCV.2019.00028.

1. A computer-implemented method of processing magnetic resonance (MR) imaging data, the method being performed by a computer processing system and comprising:
receiving MR imaging data for a region of interest in a body of a human or animal subject;
inputting the MR imaging data to a trained machine learning model;
operating the trained machine learning model to generate location data representative of a probability of cancer at a location in the region of interest; and
processing the location data to generate a human-readable image of the region of interest indicative of a probability of cancer at the location.

2. The method of claim 1, wherein the region of interest comprises at least a portion of a prostate.

3.-4. (canceled)

5. The method of claim 1, wherein the location data comprises, for each of one or more MR images in the MR imaging data, a respective probability map comprising, for each of a plurality of pixels in the MR image, data indicative of a probability of the region of the body containing cancer at a location corresponding to the respective pixel.

6.-9. (canceled)

10. The method of claim 5, further comprising processing the location data to generate, for at least one of the one or more MR images in the MR imaging data, a lesion detection map comprising, for each pixel in the MR image, a binary indicator having a first value when the respective pixel is determined to correspond to a location containing cancer, and having a second value when the respective pixel is determined to correspond to a location not containing cancer.

11. The method of claim 10, wherein generating the lesion detection map comprises:
for each of a plurality of voxels extracted from the one or more MR images in the MR imaging data, comparing data indicative of a probability of a location corresponding to said voxel containing cancer to a voxel-level threshold value; and
determining one or more candidate lesions, each candidate lesion comprising a group of adjacent voxels having associated probabilities that exceed the voxel-level threshold value.

12. The method of claim 11, wherein generating the lesion detection map comprises:
determining a respective diameter and/or volume of each candidate lesion;
comparing each respective diameter and/or volume to a size threshold value; and
discarding each candidate lesion having a respective diameter and/or volume falling below the size threshold value.

13. The method of claim 11, wherein generating the lesion detection map comprises applying an erosion filter to each candidate lesion, and discarding any candidate lesions which are substantially removed through application of the erosion filter.

14. The method of claim 12, wherein generating the lesion detection map comprises:
calculating, for each candidate lesion, a respective probability indicative of a likelihood of the candidate lesion corresponding to a region of clinically significant cancer;
calculating a lesion-level threshold value based on the respective probabilities associated with each candidate lesion; and
discarding each candidate lesion having a respective probability falling below the lesion-level threshold value.

15. The method of claim 11, wherein generating the lesion detection map comprises:
assigning a binary indicator having the first value to each voxel of each remaining candidate lesion; and
for an MR image of the one or more MR images, determining which of the voxels associated with a binary indicator having the first value correspond to pixels in the MR image, and projecting the binary indicators associated with said voxels onto said corresponding pixels of the MR image.

16. The method of claim 1, wherein the trained machine learning model comprises a trained radiomics-based classifier model.

17. (canceled).

18. The method of claim 1, wherein the trained machine learning model comprises a generative model trained using a generative adversarial network.

19.-20. (canceled)

21. The method of claim 18, wherein operating the trained machine learning model comprises:
generating, for each of one or more MR images in the MR imaging data, a respective synthetic MR image representative of a non-cancerous version of the region of interest; and
determining a pixel-wise difference between each MR image and the respective synthetic MR image to generate a respective difference image;
wherein processing the location data to generate a human-readable image comprises calculating, for each difference image, local maxima across the difference image.

22.-25. (canceled)

26. A method of training a machine learning model for processing magnetic resonance (MR) imaging data, the method being performed by a computer processing system and comprising:
receiving training data comprising, for each of a plurality of human or animal subjects, respective MR imaging data for a region of interest in the body of the human or animal subject and associated diagnosis data comprising an indication of whether the MR imaging data represents clinically significant cancer in the region of interest; and
using the training data to train a machine learning model that is arranged to receive, as input, MR imaging data of the region of interest in a body of a human or animal subject, and to generate, as output, location data representative of a probability of cancer at a location in the region of interest.

27.-33. (canceled)

34. The method of claim 26, further comprising processing the training data by performing intensity normalisation over each of one or more MR images in the training data.

35. The method of claim 34, wherein the intensity normalisation is performed by performing dual-reference tissue-normalisation over each of one or more MR images in the training data.

36. The method of claim 34, wherein the intensity normalisation is performed using an AutoRef normalisation method.

37.-43. (canceled)

44. The method of claim 26, further comprising processing the training data by generating, for each of one or more MR images in the training data, a respective plurality of cropped images using a random or strided cropping process.

45. (canceled)

46. The method of claim 44, comprising generating the cropped images using a CroPRO cropping method.

47. A computer-readable storage medium comprising instructions that, when executed by a computer processing system, cause the computer processing system to perform a method comprising:
receiving MR imaging data for a region of interest in a body of a human or animal subject;
inputting the MR imaging data to a trained machine learning model;
operating the trained machine learning model to generate location data representative of a probability of cancer at a location in the region of interest; and
processing the location data to generate a human-readable image of the region of interest indicative of the probability of cancer at the location.

48. (canceled)

49. The method of claim 1, wherein the trained machine learning model comprises a plurality of individually-trained models, and wherein operating the trained machine learning model to generate location data comprises ensembling respective outputs from the plurality of individually-trained models.
